(19) United States
(12) Patent Application Publication
(10) Pub. No.: US 2002/0144101 A1
(43) Pub. Date: Oct. 3, 2002

(54) Caching DAG traces

(76) Inventors: Hong Wang, Fremont, CA (US); Neil A. Chazin, Santa Clara, CA (US); Christopher J. Hughes, Urbana, IL (US); Ralph Kling, Sunnyvale, CA (US); John Shen, San Jose, CA (US); Yong-Fong Lee, San Jose, CA (US)

Correspondence Address: FISH & RICHARDSON, PC, 4350 LA JOLLA VILLAGE DRIVE, SUITE 500, SAN DIEGO, CA, 92122, US

(21) Appl. No.: 09/823,235

(22) Filed: Mar. 30, 2001

(51) Int. Cl. G06F 9/00

(52) U.S. Cl. 712/240

(57) ABSTRACT

A DAG trace cache includes traces, each storing information about interdependent instructions and the interdependency among the instructions. The interdependent instructions include a criterion instruction and are part of a program sequence that is stored in an instruction cache. The information is in the form of a directed acyclic graph. The interdependent instructions include the criterion instruction and instructions preceding the criterion instruction in the program sequence. The information in the DAG trace is used to accelerate executions of the instructions on a processor.

### TECHNICAL FIELD

This invention relates to caching DAG (directed acyclic graph) traces.

### BACKGROUND

In the following description of the embodiments, reference is made to the accompanying drawings that show, by way of illustration, specific embodiments in which the invention maybe practiced. In the drawings, like numerals describe substantially similar components throughout the several views. These embodiments are described in sufficient details to enable people skilled in the art to practice the invention. Other embodiments may be utilized and structural, logical and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following description is, therefore, not to be taken in a limiting sense.

Referring to FIG. 1, a processing system 10 includes a processor 11, a data cache 12, and a main memory 13. Within processor 11, an instruction cache 14 stores a program, or a sequence of instructions, for the processor to execute. In the scenario illustrated in FIG. 1, a pipeline 15, which is a simplified example for demonstrating the executions of instructions, is included in processor 11. Pipeline 15 executes the instructions and generates results to be stored in data cache 12 or main memory 13. Pipeline 15 includes stages, each executing a function in parallel with, and independent of, executions in other stages. For example, the first stage of pipeline 15 is generally a fetch stage 151 that fetches an instruction from instruction cache 14. A decode stage 152 following fetch stage 151 decodes the fetched instruction into an opcode (e.g., Add, Subtract, and Load) and one or more operands (e.g., register 5). Subsequently, a register read stage 153 fetches operand values of the operation specified in the decoded instruction from registers (not shown) in pipeline 15, and sends the instruction to functional units (such as arithmetic and logic units) at an execution stage 154 to perform the arithmetic and logic operation specified by the opcode. For load and store instruction, stage 154 is also responsible for access data cache 12 hierarchy. A write-back stage 155 commits the results of the operation to the registers (not shown).

To increase execution speed, stages of pipeline 15 can operate at the same time on different instructions. For example, while decode stage 152 is decoding an instruction, fetch stage 151 can fetch another instruction from instruction cache 14. However, the decision as to which instruction to fetch is often based on the results of previous instructions. For example, depending on the results of the instructions preceding a branch instruction (e.g., an if-statement), a branch in the sequence of instructions may or may not be taken. Fetch stage 151 may use a branch prediction algorithm to determine whether the next instruction to fetch is sequentially the next instruction in the program sequence. The next instruction in the program sequence is also called a fall-through instruction, which is fetched if the branch is predicted not taken. If the branch is predicted taken, an instruction at the branch target is fetched.

If branch is mispredicted, the instructions fetched by mistake, between the time when the branch was fetched and when the branch is computed in execute stage 154, need to be removed from pipeline. Consequently, long latency will occur for pipeline 15 to remove the partially executed fetched instruction and to retrieve the actual next instruction. This latency is usually called branch misprediction penalty.

Similar to branch instructions, the load instructions can stall the operations on pipeline 15. Specifically, the load instructions load a data block from data cache 12 to the registers of pipeline 15. If that data block is not in data cache 12 (i.e., a cache miss occurs), pipeline 15 may stall as a result until the data block is brought into the cache from main memory 13 or other secondary data storages.

### DESCRIPTION OF DRAWINGS

FIG. 1 is a diagram of a processing system for executing instructions;

FIG. 2 is a diagram of another processing system for executing instructions;

FIG. 3A is a DAG (directed acyclic graph) representing interdependent instructions;

FIG. 3B is an array storing a representation of the directed acyclic graph;

FIG. 4 illustrates a data structure of a DAG trace cache;

FIG. 5 is another directed acyclic graph with subslice classification results; and

FIG. 6 is an example of a subslice classification algorithm.

### DETAILED DESCRIPTION

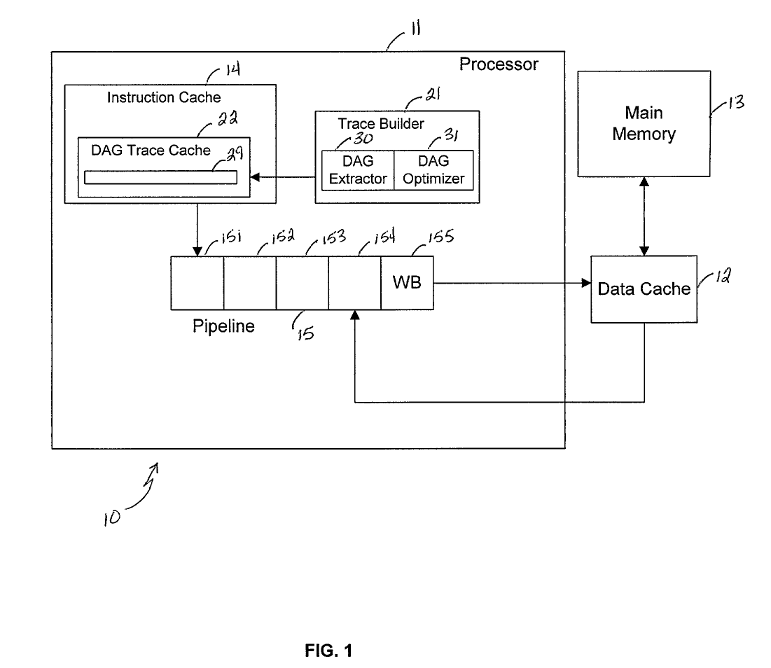

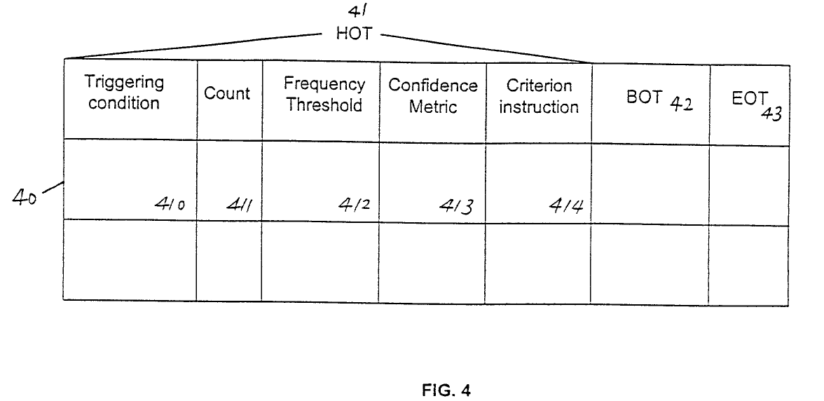

Referring to FIG. 1, processor 11 includes a DAG trace cache 22 for storing DAG traces. Each DAG trace contains information about a group of interdependent instructions among which data dependency exists. The information stored in DAG trace 22, as will be described in detail below with reference to FIG. 4, allows pipeline 15 to dynamically predict or pre-compute in outcome of a criterion instruction in attempt to prevent the criterion instruction from incurring long latency. The interdependent instructions include a criterion instruction, which is either a branch instruction or a load instruction that can incur long latency when executed by pipeline 15. The interdependent instructions also include the instructions, called associated instructions, from which the criterion instruction has data dependence. For example, assume that a branch bases its outcome on the sign of a value V (e.g., if V>0, then instruction_block_1, else instruction_block_2). Prior to the branch, V is assigned the value of a register R. The criterion instruction, in this example, is the branch. The associated instructions include the instruction that assigns the value of register R to V, and, if any, the instructions that modify the value of register R before it is assigned to V. DAG trace cache 22 can be stored as a separate entity from instruction cache 14, or can be logically embedded as part of an instruction cache 14 and reside in any cache lines of the instruction cache that are marked as part of the trace cache. Processor 11 further includes a trace builder 21 that constructs the DAG traces from the instructions stored in instruction cache 14 or from the committed instructions and their execution results generated by pipeline 15. The traces built by trace builder 21 are placed in trace cache 22.

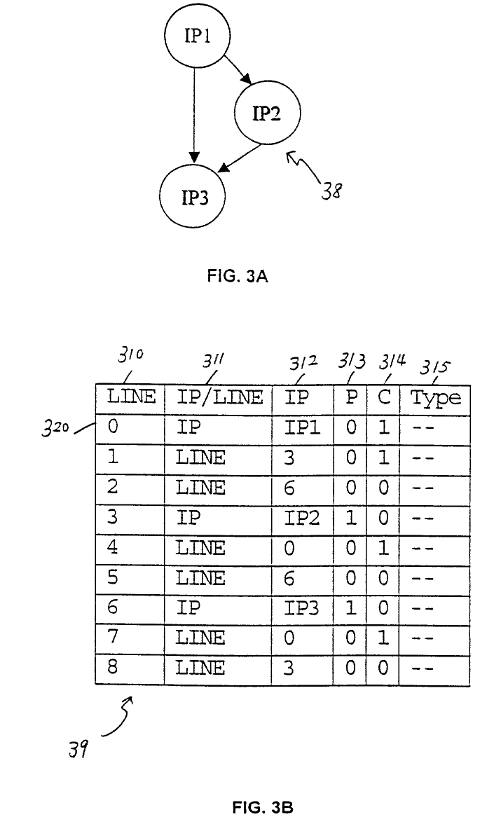

Conceptually, a criterion instruction and its associated instructions can be represented by a directed acyclic graph (DAG) 38, as shown in FIG. 3A. A DAG includes nodes representing instructions, with each node connected to one or more other nodes in the DAG. Between any two connected nodes, there is a directed line that points to either one of the nodes. The directed line represents the dependency between the two instructions represented by the two connected nodes. The instruction being pointed to (i.e., the child) is dependent on the other instruction (i.e., the parent). A DAG represents a portion of an operative program; therefore, a DAG is acyclic, just as an operative program contains no circular dependency. To illustrate the acyclic property, one may start from any node in a given DAG, and trace the direction of a connecting line that leads to another node. Repeating the same for the other node, and continues doing so for the next node, and so forth, one will never return to the starting node.

A DAG can be traced from a number of starting nodes to reach the node representing the criterion instruction. Therefore, given a sequence of interdependent instructions and its corresponding DAG representation, it is possible to change the order of the sequence of the instructions without changing the corresponding DAG representation. The last instruction of the sequence must always be the criterion instruction, because the criterion instruction directly or indirectly depends from all the other instructions in the sequence.

Processor 11 typically repeatedly runs certain programs, e.g., operating system scripts, or portions of a program sequence, such as a loop. As a result, the criterion instructions in the programs, as well as their corresponding DAGs, are also executed repeatedly. As described above, because these criterion instructions depend on their preceding instructions, one would not know which instruction or data entry to fetch until the execution, or resolution, of these preceding instructions. Nevertheless, the information in a DAG trace, derived from previous execution results or a priori knowledge of the programs, allows pipeline 15 to dynamically predict or pre-compute execution results of a criterion instruction. Pipeline 15 is therefore able to pre-fetch future instructions if the criterion instruction is a branch, or data cache entries if the criterion instruction is a load.

DAG Trace builder 21 employs a DAG extractor 30 to extract a DAG that represents a criterion instruction and the associated instructions. Information about these instructions is stored as a DAG trace in DAG trace cache 22 with other related information as will be described in detail below. When a predetermined triggering condition for the DAG trace is met, the instructions of the trace are fetched from DAG trace cache 22, decoded (if the DAG trace originally captured is not saved in a decoded format) and executed speculatively in order to predict and/or pre-compute the result of the criterion instruction, e.g., a direction of a branch, a target of a branch, or the data reference address to be accessed soon by the program sequence. In parallel with the speculative executions, pipeline 15 executes the original instruction sequence as if there were no predictions or pre-computation by the DAG trace execution. When pipeline 15 resolves the criterion instruction and the associated instructions in the original instruction sequence, the results of the speculative executions will be either confirmed and adopted, or discarded.

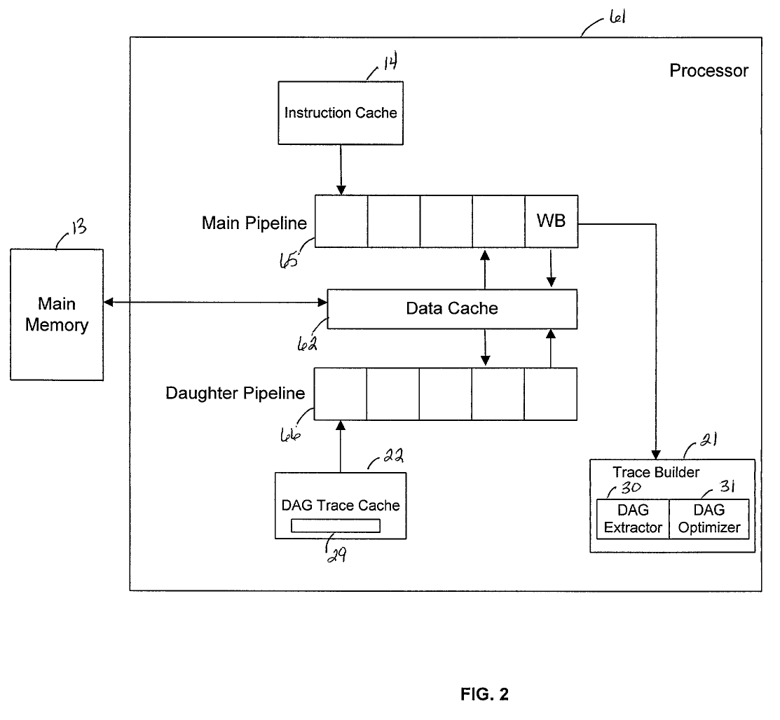

In one embodiment in which pipeline 15 has simultaneous multithreading (SMT) support, instructions of a DAG trace and the instructions pre-fetched as a result of executing the trace, can be executed as a distinct speculative thread on the pipeline. The speculative thread can be executed in parallel with a main thread executing the original instruction sequence on pipeline 15. In another embodiment, the instructions executed on the speculative thread can be executed on a distinct, secondary, daughter pipeline. Referring to FIG. 2, processor 61, which can be programmed to perform the same function as processor 11, includes a main pipeline 65 and a daughter pipeline 66 disjoint from the main pipeline. In this embodiment, the main thread and the speculative thread are executed on the two disjoint pipelines. The main pipeline 65 executes instructions on the main thread while daughter pipeline 66 executes instructions on the speculative thread. The result of the speculative execution causes pre-fetches from either instruction cache 14 or data cache 62, which are shared between daughter pipeline 66 and main pipeline 65. The pre-fetches allow main pipeline 65 to improve performance. In both of the above two embodiments, the speculative execution do not interfere with the execution of the original instruction sequence regardless of the location in which the speculative thread is executed. In particular, the speculative executions do not write any value into the registers, neither is the speculative thread allowed to do any store into data cache 62 or main memory 13. This ensures that the speculative thread does not interfere architectural states of the main thread. In one scenario, trace builder 22 and DAG extractor 30 are software procedures of a compiler, or a runtime system (e.g. dynamic monitoring and optimization tools like Intel Vtune®, a product by Intel Corporation, Santa Clara, Calif.) that runs on processor 11. Through profiling the original instruction sequence, DAG extractor 30 identifies criterion instructions that may incur long latency. DAG extractor 30 then captures these criterion instructions and their respective associated instructions by sliding an analysis window of a predetermined size down the original instruction sequence. When an identified criterion instruction moves into the bottom of the window, all the instructions in the window are captured as initial candidate instructions for a DAG trace, since potentially, the criterion instruction is data dependent upon all of them. Trace builder 21 examines the captured instructions and discards those having no interdependency relationship with the criterion instruction. The remaining instructions are built into a DAG trace and saved in a trace file, which has a binary format and can be directly loaded by a loader into trace cache 22. It should be noted that many choices exist with respect to whether the DAG traces are built in the same binary as the original program binary, or the DAG traces are saved as a distinct trace file that is separate from the original program binary. If the DAG traces are built in the same binary as the original program binary, the loader only needs to load one single binary consisting of both original program and the DAG traces. Otherwise, the loader is responsible for separately loading in both the original program binary and the associated trace file.

In addition, depending on implementation choices, the format or representation of instructions in a DAG trace can differ across a wide spectrum, ranging from as simple as storing individual instruction address only, to storing pre-decoded format of instruction. If pre-decoded format is stored, the trace instructions, once fetched, will not need to go through the decode stage in the pipeline.

Alternatively, trace builder 22 and DAG extractor 30 can be implemented using hardware exclusively or a combination of software and hardware. In a more elaborate alternative scenario, the compiler can identify the criterion instructions that may incur long latency by hint bits, which mark these criterion instructions as candidates for being included in DAG trace cache 22 at runtime. In another scenario, a candidate criterion instruction can also be determined in hardware at runtime without assistance from the compiler. DAG extractor 30 uses a dynamic detection mechanism that determines the candidates, which have induced latency penalties in previous dynamic executions. This can be accomplished by special hardware that tracks and maintains a table of candidate criterion instructions. For example, a load instruction incurring a cache miss can be placed into the table as a candidate, if the latency of the miss, measured by the time required to retrieve the data for the load instruction and place it in data cache 12, exceeds a predetermined time threshold. This can also be accomplished through simple heuristics such as cache line fill from memory tends to serve long latency cache misses, thus any load miss serviced by such cache line fill can be treated as a candidate for criterion instruction. The candidates can be further filtered to select the ones incurring latency with a frequency exceeding a predetermined recurrence threshold, or the ones incurring long and uncertain latency, as determined from the mean and variance of the latency. Once a criterion instruction is identified as a criterion instruction candidate for building a DAG trace, DAG extractor 30 may need to determine whether or not the trace already exists in trace cache 22, which can happen when the trace is built dynamically based on previous executions. In addition, depending upon different dynamic behavior of a program sequence at different times, the DAG trace for a criterion instruction may need to be updated to reflect the behavior change in the dynamic execution of the program.

Like traditional cache structures, DAG trace cache 22 physically includes a tag array and a data array. Each element in the tag array is an index that uniquely identifies a corresponding element in the data array. The element of the tag array stores the IP (Instruction Pointer) of the first instruction of a DAG trace, while the corresponding element of the data array stores the instructions or pointers to the instructions that form the trace. To locate a DAG trace in trace cache 22, DAG extractor 30 uses an instruction address or instruction pointer as key to perform an associative lookup on the tag array of the trace cache.

DAG extractor 30 can also locate a DAG trace using the IP of the last instruction of the trace, i.e., the criterion instruction of the trace. As describe above, a DAG can represent an interdependent instruction sequence, i.e., instructions of a DAG trace, in various permutation orders. If the trace exists in a form that has a different first instruction, DAG extractor 30 would not be able to locate the trace with its first instruction. However, the last instruction of the trace is always the criterion instruction. Therefore, an ancillary tag array, also called an inverted tag array, can be used to store the IP of the criterion instruction of a DAG trace. The tag array and the ancillary tag array can co-exist in DAG trace cache 22. The two arrays can be implemented physically as two separate arrays, or only logically separate but physically implemented in the same tag array with a bit in each entry of DAG trace cache 22 to distinguish to which of the two arrays a given tag (or the corresponding IP) belongs. Once DAG extractor 30 identifies a criterion instruction as a candidate, and determines that the criterion instruction and its associated instructions do not exist in trace cache 22, DAG extractor 30 captures the instructions. DAG extractor 30 can use a hardware buffer, e.g. a FIFO (First-In-First-Out) buffer, just like the analysis window used by the compiler. The FIFO captures criterion instructions once any of them enters the FIFO. Once a criterion instruction enters, the criterion instruction, together with the instructions preceding it, will be captured and taken out of the FIFO. The captured instructions may include the ones that are not related to the criterion instruction. Based on observations of previous executions of the criterion instruction and data dependency analysis, DAG extractor 30 removes the unrelated instructions and sends the rest of the instructions to trace builder 21 for trace construction. The size of the FIFO, just like that of the analysis window, determines an upper bound for the size of the DAG representing the DAG trace.

In one embodiment, trace builder 21 further employs a DAG optimizer 31 to optimize the instructions captured by DAG extractor 30. One approach is to bypass redundant instructions in the DAG. For example, assume that a value A is assigned to a register B, and the value of register B is then assigned to another register C. DAG optimizer 31 may simply assign value A directly to register C to bypass the operation that involves register B. DAG optimizer 31 may further pack multiple independent DAG traces that are adjacent in the original instruction sequence into a single VLIW (Very Long Instruction Word) trace for parallel executions. The VLIW trace, however, requires processor 11 to have wide VLIW execution resources for executing these independent DAG traces in parallel.

The result of the optimization is a group of interdependent instructions, which can be stored in an array. The array captures the complete dependency relationship of the instructions and thus the corresponding DAG. Referring to FIG. 3B, an array 39 stores dependency information of the instructions in DAG 38 of FIG. 3A. Array 39 contains a number of lines, and each line further includes a number of elements. Each line includes a line element 310 containing a line number of the line; an IP/Line element 311 indicates whether an IP element 312 contains the IP of an instruction in DAG 38, or contains a line number of another instruction in the DAG. The line also includes two one-bit fields 313, 314 labeled by ‘P’ and ‘C’, respectively. A ‘1’ in “P” field 313 indicates that the next line in the array is a pointer to a parent of the node, and a ‘1’ in ‘C’ field 314 indicates that the next line is a pointer to a child of the node. A line with a ‘0’ in both fields, however, indicates that the dependency relationship of the node is completely defined by the line and the lines above it, and that either another node starts from the next line, or the line is the last one for the DAG. The line may further include a type field 315 for storing classification results of the instruction in that line. Classifying the instructions further accelerates the execution of instructions, but requires the DAG trace of the instructions to be divided into subslices, as will be described below.

The first line 320 of array 39 typically contains the IP of the first instruction in DAG 38, which is also the first instruction coming out of the FIFO or the analysis window. However, the first line 320 of array 39 can alternatively store the IP of the criterion instruction, because the instructions are typically classified into subslices starting from the criterion instruction.

Referring to FIG. 4, trace builder 21 builds a DAG trace 40 according to information stored in array 39. In general, trace 40 includes a head of trace (HOT) 41 for storing the IP of the first instruction of the corresponding DAG; a body of trace (BOT) 42 containing decoded and scheduled instructions of the DAG or the IPs of these instructions; and an end of trace (EOT) 43 marking up the end of the trace. In some embodiments where the end of a DAG trace is specified in HOT 41, EOT 43 may not exist.

HOT 41 may specify a triggering condition 410 for trace 40. Before trace 40 is fetched from trace cache 22, the triggering condition 410 of trace 40 is checked to determined if the trace should be executed. Triggering condition 410 can be satisfied, for example, when a predetermined triggering instruction has just been fetched and/or decoded by main pipeline 65 or by the main thread executed on pipeline 15. In general, a triggering instruction can be any instruction indicating that the criterion instruction of a DAG trace may be executed. The triggering instruction does not necessarily have a dependency relationship with the criterion instruction of the DAG trace, and can be inserted into the original instruction sequence by the compiler or hardware. In addition to the IP of a triggering instruction, the triggering condition can also include additional architectural state comparisons and/or micro-architectural state (i.e., architecturally invisible machine state) comparisons. For example, a DAG trace may be triggered only when a triggering instruction is fetched and when the criterion instruction also incurs enough misses to exceed a certain threshold. The threshold is a form of micro-architectural state. HOT 41 can store the triggering instruction or the IP of the triggering instruction as an index for trace 40. When pipeline 15 or main pipeline 65 encounters a triggering instruction, it does a lookup in trace cache 22 to determine whether or not to execute trace 40. The lookup operation does not need to be very fast because the pipeline has not actually encountered the instructions of trace 40 in the original instruction sequence. However, it is required that trace 40 be speculatively executed before main pipeline 65 or the main thread of pipeline 15 encounters the criterion instruction. Pipeline 15 or main pipeline 65 may turn off the triggering conditions of trace 40. In one scenario, the triggering conditions may be turned off if the result of executing trace 40 is wrong most of the time. In some embodiment, this condition could also be used as heuristics to indicate obsoleteness of the current DAG trace and force discarding the current DAG trace and building new DAG trace for the criterion instruction. In another scenario, pipeline 15 or main pipeline 65 may not have enough resources to speculatively execute trace 40.

HOT 41 does not need to specify a triggering condition 410 if, for example, a passive run-ahead technique is used to determine when a DAG trace 40 should be triggered. This technique requires that a DAG trace 40 be triggered only when a stall condition on main pipeline 65 (or the main thread on pipeline 15) occurs. The stall may be caused by flushing incorrectly fetched instructions on mispredicated path from pipeline 15, a miss in data cache 12, thread switching on multithreaded pipeline such as simultaneously multithreaded (SMT), or switch-on-event multithreaded (SOEMT). The DAG trace 40 to be triggered is generally the DAG trace that closely follows the instruction incurring the stall.

In another embodiment, multiple DAG independent traces are packed into one VLIW and executed in parallel. When one of the DAG traces is triggered, all the other traces in the same VLIW are triggered as well. In some other situations, multiple data dependent DAG traces can be chained together serially. When the first trace of the chain is triggered, the other traces in the chain will also be triggered in a sequential order as specified in the chain of data dependency. If the criterion instruction of one DAG trace is depended upon by multiple DAG traces leading to multiple criterion instructions, then a multi-way DAG trace can be built so that once a criterion instruction is executed, more than one consecutive dependent DAG traces can be initiated in parallel. In a DAG trace cache organization, serially chained DAG traces is represented via the field of next trace in HOT 41. For multi-way DAG trace, its HOT consists of multiple next trace fields, each leading to another DAG trace.

HOT 41 may further include a confidence metric 413 to indicate the likelihood of correctness if trace 40 is speculatively executed. Confidence metric 413 is based on past executions of DAG trace 40 and is adjusted each time the DAG trace is executed according to the result of the execution, in comparison with the result of execution of the same instruction by the original program sequence. Confidence metric 413 can also be used to determine when DAG trace 40 should be replaced or rebuilt. When DAG trace cache 22 is full, and a new DAG trace needs to enter the DAG trace cache, one of the existing traces must be replaced. Confidence metric 413 indicates whether or not DAG trace 40 is least likely to provide correct or useful information. If the confidence metric 413 of DAG trace 40 indicates that the trace is least likely to be correct or useful among all the traces in DAG trace cache 22, DAG trace 40 will be replaced with the new trace.

DAG trace cache 22 can also use other replacement policies, e.g., the LRU (Least Recently Used), to determine if the cache entries that store trace 40 should be replaced. The LRU ensures that an entry that has not been recently accessed will be replaced quickly. It should be noted that when an entry is replaced, all the other entries that make reference to the replaced entry must be invalidated.

As described above, confidence metric 413 can also be used to determine if trace builder 21 should rebuild DAG trace 40. When confidence metric 413 falls below a pre-selected confidence threshold, the trace can be rebuilt using information about most recent executions of the original instruction sequence to reflect any dynamic changes. When the criterion instruction of DAG trace 40 resides in a loop of only a few instructions, the result of the criterion instruction will usually be hard to predict for the first several iterations of the loop, after which, however, a steady state will be reached and accuracy of the prediction will be improved. Therefore, a DAG trace 40 is best rebuilt after the steady state is reached. Each DAG trace 40 can use a counter 411 to count the number of times the trace is accessed in order to ensure that the trace has reached the steady state. DAG trace 40 is rebuilt when its counter 411 equals a frequency threshold 412 specified for the trace, and when the confidence metric 413 is also below the confidence threshold. Counter 411 is reset when DAG trace 40 is rebuilt. There are several approaches for determining the frequency threshold 412 for a DAG trace 40. The compiler can provide hint information to specify the number of iterations required for the trace to reach steady state. The special hardware used by DAG extractor 30 for dynamic detection of trace candidates can also provide similar information. Alternatively, linear, nonlinear, or exponential back-off techniques can be used. For example, an exponential back-off technique requires that each time trace builder 21 rebuilds a DAG trace 40, the trace builder waits twice as long as last time it waits, up to a predetermined time limit.

HOT 41 or EOT 43 may also include information that specifies the pointers to the next trace, e.g., in a multi-way trace as described above.

HOT 41 or EOT 43 may also include a next trace field to specify a pointer to the next fragment of the same trace. For example, when a DAG trace is longer than the line size of the physical trace cache 22, the trace is broken into multiple fragments each having a size equal to the cache line size. The consecutive fragments are chained by pointers that are stored in the HOT 41 or EOT 43 of the respective cache lines. From these pointers, the trace can be dynamically reconstructed at runtime by concatenating these fragments.

In some embodiment, the next trace field can be controlled by additional prediction algorithm to speculatively correlated two DAG traces. The additional DAG trace prediction algorithms are similar to branch prediction. In a more sophisticated embodiment, additional information used to gauge inter-trace correlation can be encoded in the next trace field as well, such as partial information of HOT to allow certain states to be shared or communicated between two correlated DAG traces. Other additional information in HOT 41 further allows processor 11 to produce predictions with improved performance or accuracy. The information generally includes: the criterion instruction of trace 40, live-in (the collection of source operands) and live-out (the collection of destination operands) information, or information related to EOT 43.

BOT 43 stores instructions of a DAG trace or pointers to these instructions. To compact the size of BOT 43, instructions of a DAG trace can be grouped into subslices. The subslices can be identified by classifying the instructions of the DAG trace. After the subslices are identified, BOT 42 will store the references to the subslices. Therefore, if multiple DAG traces contain the same subslice, DAG trace cache 22 will only duplicate the references to the subslice.

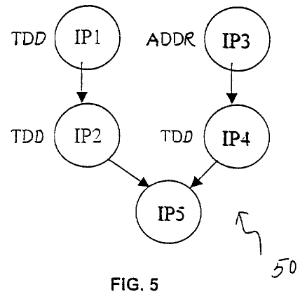

Referring to FIG. 5, a DAG 50 includes five nodes, each representing an instruction. The criterion instruction is represented by IPS. The five instructions are classified into two subslice types: a True Data Dependency (TDD) subslice, which includes all arithmetic and logical operations that contribute to the result of the criterion instruction, and an Address (ADDR) subslice, which includes address calculations of the loads and the stores that contribute to the result of the criterion instruction, along with the loads and the stores. Additionally, subslice types may further include: an Existence (EX) subslice, which includes branches that affect whether or not the criterion instruction is executed; and a Control Flow (CF) subslice, which includes all the branches that affect the result of the criterion instruction, but do not affect whether or not the criterion instruction is executed. A subslice can include instructions that do not have direct dependency relationship with other instructions in the same subslice. For example, IP1, IP2, and IP4 in FIG. 5 belong to the same TDD subslice, where IP4 is neither dependent on, nor depended by, IP1 or IP2.

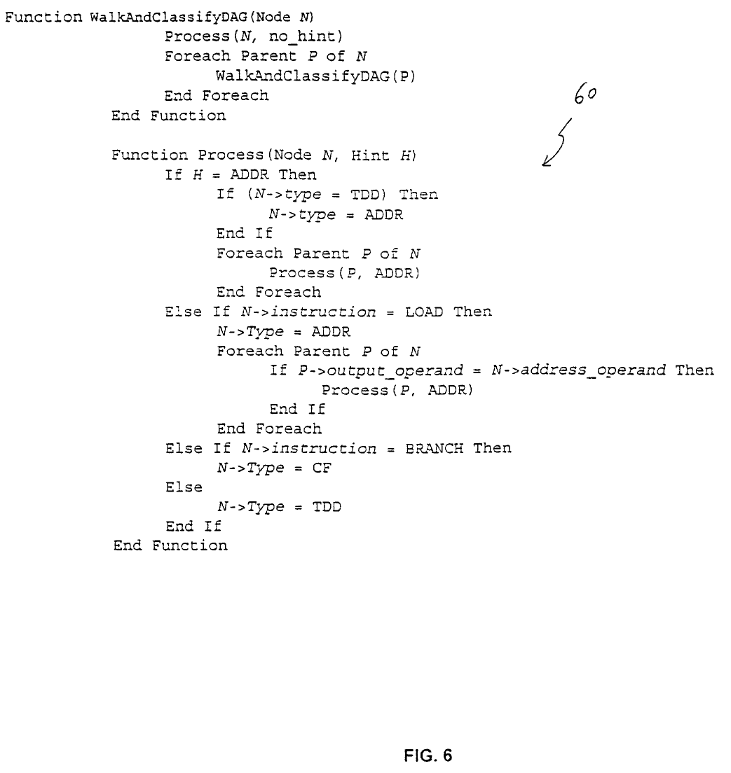

FIG. 6 illustrates an example of a classification algorithm 60 run by trace builder 21 for classifying the instructions of a DAG trace. Classification algorithm 60 initially assumes that all nodes of the corresponding DAG belong to the TDD subslice type. Then, starting from the criterion instruction, algorithm 60 dynamically classifies each of the other nodes in the DAG. If trace builder 21 runs the classification algorithm on DAG 38 of FIG. 3A, the result of the classification will enter ‘type’ field 315 of array 39 in FIG. 3B.

Classification algorithm 60 can be implemented as a state machine in either hardware or software. Optimization techniques applied on a DAG trace, as described above, can also be performed on a subslice.

Once the subslices are identified, they can be placed into a portion of trace cache 22 assigned to subslices, called a subslice cache 29 that contains subslice entries. Instead of caching an entire subslice in a single subslice entry, each subslice entry only stores a dependent piece of the subslice, that is, instructions that have direct dependency relationship and belong to the same subslice type. In the corresponding DAG, a dependent piece of the subslice contains the nodes that are connected and belong to the same subslice type.

Referring again to the example of FIG. 5, the TDD subslice includes three instructions represented by IP1, IP2, and IP4. IP1 and IP2 is one dependent piece of the TDD subslice, and IP4 is the other dependent piece of the TDD subslice. IP3, the only node in the ADDR subslice, is a dependent piece of the ADDR subslice. Each of the dependent pieces is stored in a subslice entry.

Trace builder 21 employs a hardware mechanism to copy the instructions from the array, such as the one in FIG. 3B, into subslice cache 29 in the form of subslice entries. Each subslice entry contains a dependent piece of a subslice. Before a new subslice is saved, trace builder 21 will check if the new piece of the subslice has the same first instruction as a piece of a subslice that already exists in subslice cache 29. If such a piece exists, the new piece will be discarded, and the trace containing the new piece will point to the existing piece. The new piece is discarded base on the assumption that, if two pieces have the same first instruction, other instructions in the two pieces will also be the same. The assumption, however, may not be always true. The other instructions in the existing piece may be different from those of the new piece, thus causing the prediction of the corresponding trace to be incorrect. However, the incorrectness of the prediction will not affect the correctness of the overall program, because the speculative execution of DAG traces will not interfere architectural states of the main thread. Equally significantly, the criterion instruction of the trace and all the associated instructions will eventually be executed in the main thread on pipeline 15, or on main pipeline 65. After these instructions are executed, the pre-fetched instructions as a result of the incorrect prediction will be discarded from the speculative thread on pipeline 15, or from daughter pipeline 66.

Trace builder 21 checks if a subslice, or a piece of a subslice, exists in subslice cache 29 by locating the IP of the first instruction of the subslice or the piece. Subslice cache 29, just like trace cache 22 where the subslice cache resides, physically includes a tag array and a data array. Locating a subslice in subslice cache 29 can be performed in the same way as locating a DAG trace in trace cache 22 as described above. Other embodiments are within the scope of the following claims.

What is claimed is:

1. An apparatus comprising:
a cache of traces, each trace including information about interdependent instructions among which data dependency exists, the interdependent instructions including a criterion instruction that is part of a program sequence.

2. The apparatus of claim 1 wherein the information comprises a directed acyclic graph.

3. The apparatus of claim 1 wherein the trace includes pointers to the interdependent instructions.

4. The apparatus of claim 1 wherein the trace includes the interdependent instructions.

5. The apparatus of claim 1 wherein the interdependent instructions include the criterion instruction and instructions preceding the criterion instruction in the program sequence.

6. The apparatus of claim 1 wherein the interdependent instructions are classified into subslice types, the trace including a pointer to each subslice that is formed by each type of the interdependent instructions.

7. The apparatus of claim 6 wherein each subslice is stored as dependent pieces.

8. The apparatus of claim 1 wherein the information includes a triggering condition of the trace, the interdependent instructions of the trace being executed when the triggering condition is met.

9. The apparatus of claim 8 wherein the triggering condition includes a triggering instruction in the program sequence, the triggering condition being based on evaluation of an architectural state.

10. The apparatus of claim 8 wherein the triggering condition includes a triggering instruction in the program sequence, the triggering condition being based on evaluation of a micro-architectural state.

11. The apparatus of claim 1 wherein the information further includes a confidence metric of the trace that predicts the likelihood of producing a correct result from executing the trace.

12. The apparatus of claim 11 wherein the confidence metric of the trace indicates whether or not the trace should be replaced by a new trace storing information about different instructions.

13. The apparatus of claim 11 wherein the confidence metric of the trace indicates whether or not the trace should be rebuilt using new information about the criterion instruction that arrives at the trace cache.

14. The apparatus of claim 11 further comprising a counter having a counter value that indicates the number of times the trace has been executed, the counter value, when exceeding a frequency threshold of the trace, triggering the trace to be rebuilt.

15. The apparatus of claim 1 wherein traces that are independent of each other and adjacent in the program sequence are grouped into a very-long-instruction-word for parallel executions.

16. The apparatus of claim 1 wherein traces that are data dependent of each other are chained together for serial executions.

17. The apparatus of claim 1 further comprising an instruction pointer that indexes the trace, the instruction pointer pointing to a first instruction or a last instruction of the interdependent instructions.

18. The apparatus of claim 1 further comprising:
a main pipeline executing the program sequence; and at least one secondary pipeline disjoint from the main pipeline executing the interdependent instructions.

19. The apparatus of claim 1 wherein the interdependent instructions are executed by a secondary thread on a pipeline, and the program sequence is executed by a main thread on the same pipeline.

20. A method comprising:
identifying a criterion instruction incurring latency in a program sequence;
capturing the criterion instruction and instructions preceding the criterion instruction in the program sequence, the preceding instructions and the criterion instruction being interdependent; and
storing a trace in a trace cache, the trace including information about the criterion instruction and the preceding instructions.

21. The method of claim 20 wherein the information is in a form of a directed acyclic graph

22. The method of claim 20 wherein the latency includes a long latency that exceeds a predetermined time threshold, a frequent latency that exceeds a predetermined recurrence threshold, or a long and uncertain latency that exceeds a mean threshold and a variance threshold.

23. The method of claim 20 further comprising dynamically identifying the criterion instruction based on information derived from previous executions.

24. The method of claim 20 further comprising capturing the criterion instruction and the preceding instructions by a buffer.

25. The method of claim 20 further comprising locating an existing trace in the trace cache before storing the trace, the existing trace and the trace to be stored having the same first instruction or the same last instruction.

26. The method of claim 20 further comprising rebuilding the trace after a duration of time interval that grows each time the trace is rebuilt until the duration reaches a predetermined time limit.

27. The method of claim 20 further comprising storing, in an array, the information about the criterion instruction and the preceding instructions.

28. The method of claim 27 wherein the array further includes a subslice type for each of the instructions, the subslice type being a result of classifying the instructions.

29. A computer program residing on a computer readable medium comprising instructions for causing a computer to:
identify a criterion instruction incurring latency in a program sequence;
capture the criterion instruction and instructions preceding the criterion instruction in the program sequence, the preceding instructions and the criterion instruction being interdependent; and
store a trace in a trace file, the trace including information about the criterion instruction, the preceding instructions, and interdependency among the criterion instruction and the preceding instructions.

30. The computer program of claim 29 wherein an analysis window defined in the computer program causes the computer to capture the criterion instruction and preceding instructions.

31. The computer program of claim 29 wherein the computer identifies the criterion instruction by profiling the program sequence.
